(19) United States
(12) Patent Application Publication
(10) Pub. No.: US 2009/0075128 A1
(43) Pub. Date: Mar. 19, 2009

(54) FUEL CELL SYSTEM AND METHOD FOR CONTROLLING A FUEL CELL SYSTEM

(75) Inventors: Atsushi SADAMOTO, Kawasaki-shi (JP); Takahiro Suzuki, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/234,077

(22) Filed: Sep. 19, 2008

(30) Foreign Application Priority Data
Sep. 19, 2007 (JP) 2007-242516

(51) Int. Cl. H01M 8/04; H01M 8/10

(52) U.S. Cl. 429/13; 429/30; 429/22

(57) ABSTRACT

A fuel cell system includes: a cell including an anode flow channel plate having a fuel inlet and a fuel outlet the cell generating power by reaction of the fuel with air; a circulation pump; and a check valve between the fuel outlet and the buffer tank shutting off flowing the fuel in a reverse direction, wherein the circulation pump rotate reversely to flow the fuel in the reverse direction and to collect the fuel from the cell through the fuel inlet to the buffer tank, after completion of the generation of the power.

### CROSS REFERENCE TO RELATED APPLICATIONS AND INCORPORATED BY REFERENCE

The application is based upon and claims the benefit of priority from the prior Japanese Patent Applications No. P2007-242516, filed on Sep. 19, 2007; the entire contents of which are incorporated herein by reference.

### BACKGROUND OF THE INVENTION

1. Field of the Invention

The present invention relates to a liquid-type fuel cell system and a method for controlling the fuel cell system.

2. Description of the Related Art

In recent years, fuel cells have been increasingly expected to be a power source of portable electronic instrument for an information-oriented society, and various types of fuel cells, for example, such as a direct methanol fuel cell (DMFC) have been developed.

The DMFC supplies electrical energy generated by a reaction between methanol and oxygen contained in the air to an instrument connected thereto. Unlike a so-called general battery, a fuel cell like the DMFC is a relatively complicated system including: a stack as an electromotive unit; a fuel tank that stores fuel therein; and an auxiliary equipment for stably continuing power generation. Accordingly, the entirety of the fuel cell is sometimes called a fuel cell system.

The stack is a plurality of cells that are stacked together. It is referred to as a state where electric power can be extracted after being supplied with air and fuel at appropriate flow rates. In the fuel cell system, there is a configuration in which the supply of air and treatment of water (H₂O) and carbon dioxide (CO₂), which are generated by the reaction, are achieved by a simple system. A system that supplies the air without using a blower is sometimes referred to as a self-breathing fuel cell.

In the self-breathing fuel cell, the power generation is started as soon as the fuel enters the stack, even if the air is not forcibly fed thereto. Accordingly, the self-breathing fuel cell has an advantage in that the structure thereof is simple, which permits downsizing of the system and reduces cost. On the other hand, power generation continues when the fuel is left in the stack while the fuel cell is no longer being used. Accordingly, the self-breathing fuel cell has problems in that fuel is consumed wastefully but also power generation is decreased by the water and a byproduct, which are generated by the power generation.

In order to prevent such a deterioration of the stack while the fuel cell is not operating, it is necessary to drain the fuel from the stack after the fuel cell is used. However, when a valve for shutting off a fuel circulation passage and a pump for draining the liquid are added to the structure for draining the fuel from the stack, a simple fuel cell cannot be provided.

The operation of the fuel cell system, which mainly uses gas fuel, at the time when the power generation is ended, includes a system that closes a variety of valves or introduces an inert gas to air electrodes in order to prevent performance deterioration of the stack while the stack is inoperative (refer to JP-A 2006-66107 (KOKAI)). However, the valves and flow channels are subject to substantial use and it is difficult to achieve downsizing and weight reduction for a portable electronic instrument.

There is a system that uses a check valve in order to adjust a pressure in a fuel pipe (refer to JP-A 2004-311344 (KOKAI)). In order to prevent performance deterioration caused by decreased pressure in a fuel circulation system of the fuel cell, the check valve adjusts the pressure in the fuel circulation system so as to reduce a difference between the atmospheric pressure and the pressure in the fuel circulation system so that the atmosphere is automatically introduced into the fuel circulation system when the pressure therein is reduced. However, the check valve does not function as means for draining the fuel in the fuel circulation system.

There is a method of draining the fuel from the stack by use of an electromagnetic valve and a circulation pump that rotates in reverse in order to prevent deterioration of the operation of the fuel cell (refer to JP-A 2005-32601 (KOKAI)). However, since the electromagnetic valve and a complicated control system are used, the fuel cell cannot be compact and simple.

### SUMMARY OF THE INVENTION

An object of the present invention is to provide a liquid-type fuel cell system with a simple configuration and a method for controlling the fuel cell system, which can drain fuel from a stack after completion of the generation of the power and thereby suppresses performance deterioration.

An aspect of the present invention inheres in a fuel cell system including: a fuel tank to store fuel; a buffer tank to store the fuel supplied from the fuel tank; a cell including an electrolyte membrane, an anode electrode and a cathode electrode sandwiching the electrolyte membrane, and an anode flow channel plate having a fuel inlet to supply the fuel to the anode electrode and a fuel outlet to discharge the fuel, the cell to generate power by reaction of the fuel supplied to the anode electrode with air supplied to the cathode electrode; a circulation pump to circulate the fuel in a forward direction from the buffer tank and returning to the buffer tank through the fuel inlet and the fuel outlet, during the generation of the power; and a first check valve provided in a route between the fuel outlet and the buffer tank, and to allow flowing the fuel in the forward direction, and to shut off flowing the fuel in a reverse direction of the forward direction, wherein the circulation pump rotate reversely so as to flow the fuel in the reverse direction and to collect the fuel discharged from the cell through the fuel inlet to the buffer tank, after completion of the generation of the power.

Another aspect of the present invention inheres in a method for controlling a fuel cell system including: a fuel tank to store fuel; a buffer tank to store the fuel supplied from the fuel tank; a cell including: an electrolyte membrane; an anode electrode and a cathode electrode sandwiching the electrolyte membrane; and an anode flow channel plate having a fuel inlet to supply the fuel to the anode electrode and a fuel outlet to discharge the fuel, the cell to generate power by reaction of the fuel supplied to the anode electrode with air supplied to the cathode electrode; a circulation pump to circulate the fuel in a direction from the buffer tank and returning to the buffer tank through the fuel inlet and the fuel outlet, defined as a forward direction; and a check valve provided in a route between the fuel outlet and the buffer tank, and to allow flowing the fuel in the forward direction, and to shut off flowing the fuel in a reverse direction, the method including: rotating reversely the circulation pump so as to flow the fuel in the reverse direction and to collect the fuel discharged from the cell through the fuel inlet to the buffer tank, after completion of the generation of the power.

### BRIEF DESCRIPTION OF DRAWINGS

FIG. 1 is a schematic view showing an example of a fuel cell system according to the first embodiment of the present invention.

FIG. 2 is a cross sectional view showing an example of a cell according to the first embodiment of the present invention.

FIG. 3 is a schematic view for explaining flow in a forward direction of a check valve according to the first embodiment of the present invention.

FIG. 4 is a schematic view for explaining flow in a reverse direction of the check valve according to the first embodiment of the present invention.

FIG. 5 is a schematic view for explaining flow in a reverse direction of another check valve according to the f irst embodiment of the present invention.

FIG. 6 is a schematic view for explaining flow in a forward direction of the other check valve according to the f irst embodiment of the present invention.

FIG. 7 is a schematic view for explaining normal operation of the fuel cell system according to the first embodiment of the present invention.

FIG. 8 is a schematic view for explaining a liquid drainage operation of the fuel cell system according to the first embodiment of the present invention.

FIG. 9 is a schematic view showing an example of a fuel cell system according to a second embodiment of the present invention.

FIG. 10 is a schematic view for explaining normal operation of the fuel cell system according to the second embodiment of the present invention.

FIG. 11 is a schematic view for explaining a liquid drainage operation of the fuel cell system according to the second embodiment of the present invention.

FIG. 12 is a schematic view showing another example of the fuel cell system according to the second embodiment of the present invention.

FIG. 13 is a schematic view for explaining normal operation of the other example of the fuel cell system according to the second embodiment of the present invention.

FIG. 14 is a schematic view for explaining a liquid drainage operation of the other example of the fuel cell system according to the second embodiment of the present invention.

FIG. 15 is a schematic view showing an example of a fuel cell system according to a third embodiment of the present invention.

FIG. 16 is a schematic view for explaining normal operation of the fuel cell system according to the third embodiment of the present invention.

FIG. 17 is a schematic view for explaining a liquid drainage operation of the fuel cell system according to the third embodiment of the present invention.

FIG. 18 is a schematic view showing another example of the fuel cell system according to the third embodiment of the present invention.

FIG. 19 is a schematic view for explaining normal operation of the other example of the fuel cell system according to the third embodiment of the present invention.

FIG. 20 is a schematic view a liquid drainage operation of the other example of the fuel cell system according to the third embodiment of the present invention.

FIG. 21 is a schematic view showing an example of a fuel cell system according to other embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Generally and as it is conventional in the representation of semiconductor devices, it will be appreciated that the various drawings are not drawn to scale from one figure to another nor inside a given figure, and in particular that the layer thicknesses are arbitrarily drawn for facilitating the reading of the drawings.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### FIRST EMBODIMENT

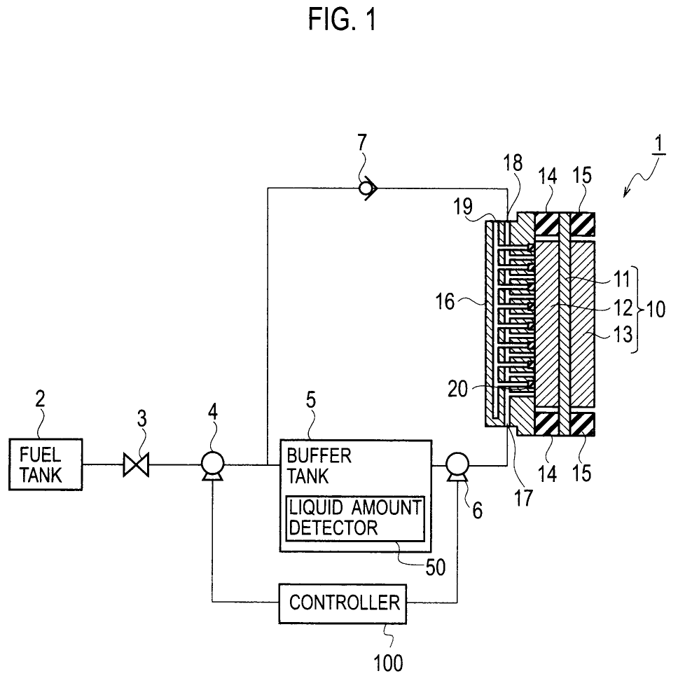

As shown in FIG. 1, a fuel cell system according to a first embodiment of the present invention includes a fuel tank (methanol cartridge) 2 that stores fuel therein; a buffer tank 5 that stores the fuel supplied from the fuel tank 2; a fuel supply pump 4 that supplies the fuel from the fuel tank 2 to the buffer tank 5; a cell (electromotive unit) 1 having an electrolyte membrane 11, an anode electrode 12 and a cathode electrode 13, which are opposite to each other while interposing the electrolyte membrane 11 therebetween, and an anode flow channel plate 16 provided with a fuel inlet 17 for supplying the fuel to the anode electrode 12, a fuel outlet 18 for discharging the fuel from the cell 1, and a gas outlet 19 for discharging a gas generated from the anode electrode 12 are also provided to generate electric power by a reaction between the fuel supplied to the anode electrode 12 and air supplied to the cathode electrode 13; a circulation pump 6 that circulates the fuel through a route from the buffer tank 5, passing through the fuel inlet 17, the cell 1 and the fuel outlet 18 and returning to the buffer tank 5. A direction of the route, as described, being a forward direction (a counterclockwise direction in FIG. 1). The fuel cell system also includes a check valve 7 disposed on the route between the fuel outlet 18 and the buffer tank 5. The check valve permits the fuel to flow in the forward direction, and prevents the fuel from flowing in a reverse direction (a clockwise direction in FIG. 10). Here, after the cell stops generating electric power, the circulation pump 6 is controlled so as to rotate reversely, whereby the fuel flows in the reverse direction, and the fuel is discharged from the cell 1 through the fuel inlet 17 and collected to the buffer tank 5.

A stack is composed of a plurality of cells that are stacked together; however, one cell 1 is illustrated in FIG. 1 for simplifying the fuel cell system. Moreover, a description will be made of a direct methanol fuel cell (DMFC) using methanol as the fuel; however, other liquid fuels such as ethanol and propanol may be used.

The fuel tank 2, a valve 3, the fuel supply pump 4, the buffer tank 5 and the circulation pump 6 are sequentially connected to one another by fuel pipes displayed simply as solid lines in FIG. 1. In a similar way, by fuel pipes displayed as solid lines in FIG. 1, the fuel inlet 17 of the cell 1 and the circulation pump 6 are connected to each other, the fuel outlet 18 of the cell 1 and the check valve 7 are connected to each other, and the check valve 7 and the buffer tank 5 are connected to each other.

The fuel tank 2 stores the fuel therein. The fuel supply pump 4 supplies the fuel, which is supplied from the fuel tank 2, to the buffer tank 5. The buffer tank 5 mixes the fuel, which is supplied by the fuel supply pump 4, and a liquid containing fuel and water, which has been discharged from the fuel outlet 18 of the cell 1, and then stores therein fuel (mixture) with a concentration suitable for electric power generation. A liquid amount detector 50 is provided in the buffer tank 5.

At the time of a normal operation, the circulation pump 6 supplies the fuel in the buffer tank 5 to the anode electrode 12 through the fuel inlet 17 of the cell 1, and circulates the liquid containing the fuel, which is discharged from the cell 1 through the fuel outlet 18, to the buffer tank 5 through the check valve 7. The circulation pump 6 and the fuel supply pump 4 are connected to a controller 100. The controller 100 controls operations of the circulation pump 6 and the fuel supply pump 4, respectively.

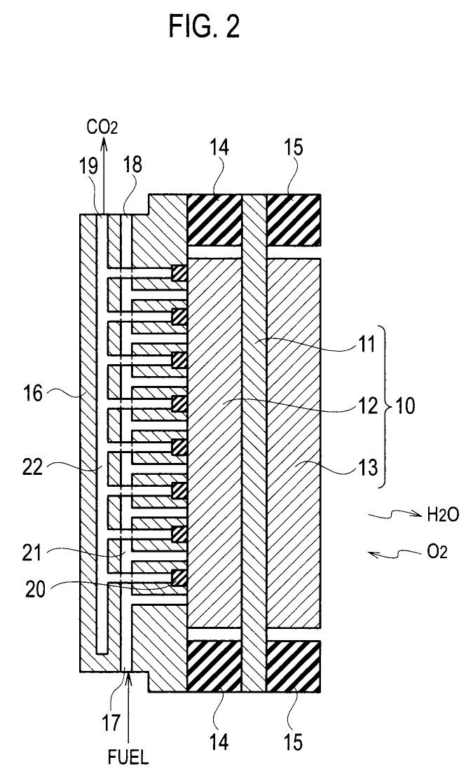

As shown in FIG. 2, the cell 1, as one unit of the stack, includes: a membrane electrode assembly (MEA) 10 which includes the electrolyte membrane 11, the anode electrode 12 and the cathode electrode 13, which are opposite to each other while sandwiching the electrolyte membrane 11 therebetween; and the anode flow channel plate 16 provided on the anode electrode 12 side.

The anode flow channel plate 16 includes a gas-liquid separation layer 20 that separates a gas and a liquid, such as unreacted fuel and the water generated by the reaction in the anode electrode 12, from each other. The gas-liquid separation layer 20 guides the liquid to the fuel outlet 18, and guides the gas to the gas outlet 19. Carbon paper, and a porous layer, such as carbon cloth and carbon unwoven fabric, which is conductive, has a hydrophobic property (water repellency) and gas permeability may be used as the gas-liquid separation layer 20.

A fuel flow channel 21 and a gas flow channel 22 are formed in the anode flow channel plate 16. The fuel flow channel 21 supplies the fuel, which is introduced from the fuel inlet 17, to the anode electrode 12, and discharges, from the fuel outlet 18, the unreacted fuel, the water generated by the reaction, and the like. The gas flow channel 22 discharges a gas (CO₂), which is generated by the reaction, from the gas outlet 19. An anode gasket 14 and a cathode gasket 15 prevent the fuel and the air from leaking to the outside.

The reactions in the anode electrode 12 and the cathode electrode 13 in the cell 1 of the stack are represented by Reaction formulas (1) and (2), respectively.

CH₃OH+H₂O→CO₂+6H⁺+6e⁻ (1)

O₂+4H⁺+4e⁻→2H₂O (2)

Protons (H⁺) generated by the anode reaction flow to the cathode electrode 13 through the electrolyte membrane 11. Electrons (e⁻) generated by the anode reaction are carried to the cathode electrode 13 via an external circuit (not shown). It is easier for CO₂ generated by the anode reaction to permeate the hydrophobic gas-liquid separation layer 20 than to form bubbles in the liquid in the fuel passage 21. Accordingly, CO₂ permeates the hydrophobic gas-liquid separation layer 20, and is discharged from the gas outlet 19. With regard to water unreacted in the anode electrode 12, a part thereof is mixed with an aqueous solution of the methanol in the fuel flow channel 21, and the rest thereof permeates the electrolyte membrane 11, and is discharged from the cathode side to the outside. With regard to water reacted by the cathode reaction, a part thereof is reversely diffused to the anode electrode 12 side through the electrolyte membrane 11, and the rest thereof is discharged from the cathode electrode 13 side to the outside.

Here, since the water is newly generated by the reactions, the reactions can be continued only by supplying high-concentration methanol and the air to the cell 1 if the water thus generated is circulated in the fuel cell system. Accordingly, the fuel is fed from the buffer tank 5 shown in FIG. 1 to the cell 1, and the water, the residual methanol and the like, which are discharged from the cell 1, are returned to the buffer tank 5.

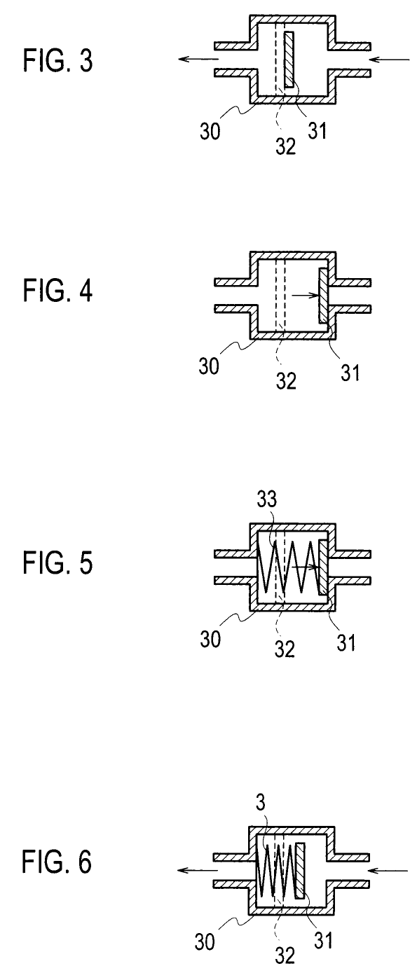

The check valve 7 permits a one-way flow of a fluid as described above, and shuts off a reverse flow thereof. As illustrated in FIG. 3, the check valve 7 includes: a valve casing 30; a valve body 31 that is disposed in the valve casing 30 and is movable in response to the flow of the fluid along a flowing direction thereof; and a stopper 32 that is disposed in the valve casing 30, holds back the valve body 31, and allows the fluid to permeate itself. When there is a flow in the forward direction from the right side to the left side, as shown in FIG. 3, the valve body 31 is pushed by the flow, separates from an inner wall of the right side of the valve casing 30, and is moved to a position where the valve body 31 contacts the stopper 32. In such a way, a flow channel is ensured. As shown in FIG. 4, when the flow is reversed, the valve body 31 is pushed by the reverse flow and moves to the inner wall of the right side, and a flow channel hole is closed. Accordingly, the reverse flow is shut off.

Moreover, as illustrated in FIG. 5, the check valve 7 may be of a type in which a compression spring 33 is added to the valve body 31. In this type of valve, the valve body 31 is thrust against the inner wall of the right side of the valve body 31 by a pressure applied by the compression spring 33 even if there is no flow. Accordingly, the flow channel hole is closed. As shown in FIG. 6, when a pressure of the flow in the forward direction from the right side to the left side provides sufficient force to compress the compression spring 33, the valve body 31 separates from the inner wall, and a flow channel is formed. In this configuration, the flow must overcome the force of the compression spring 33, and accordingly, a pressure loss is larger than in the case where the compression spring 33 is not provided. However, the configuration has advantages in that there is good shut-off performance in a state where the flow channel hole is closed, and that a threshold value (cracking pressure) can be imparted to the pressure for making the flow.

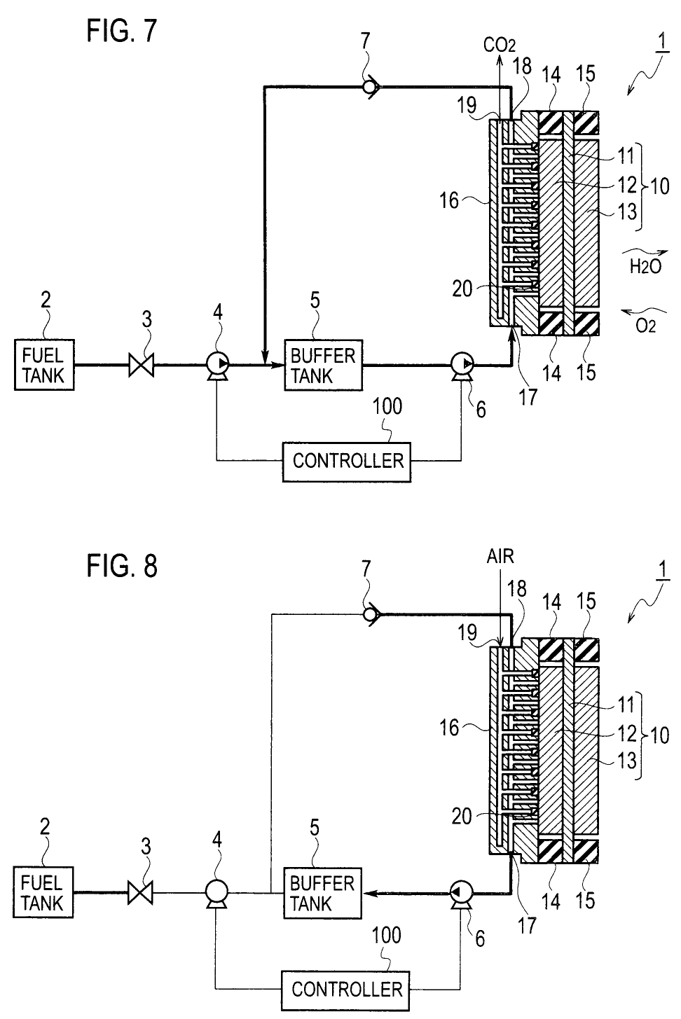

Next, a description will be made of an example of a normal operation (power generation operation) of the fuel cell system according to the first embodiment of the present invention by using FIG. 7.

At the time of the normal operation, the valve 3 is opened, and the fuel supply pump 4 supplies the fuel, which is stored in the fuel tank 2, to the buffer tank 5. The circulation pump 6 supplies the fuel, which is stored in the buffer tank 5, to the cell 1, and circulates the unreacted fuel and the like, which are discharged from the fuel outlet 18, to the buffer tank 5 through the check valve 7. In the cell 1, power is generated by a reaction between the fuel supplied to the anode electrode 12 of each cell and the air supplied to the cathode electrode 13 thereof. CO₂ generated by the power generation reaction is discharged to the atmosphere through the gas outlet 19. The fuel in the buffer tank 5 is gradually consumed by the power generation of the cell 1. Accordingly, a control operation is performed so that the fuel supply pup 4 can supply the fuel from the fuel tank 2 to the buffer tank 5 so as to make up for the consumption of the fuel, and to maintain a concentration of the fuel in the buffer tank 5 within a predetermined range.

Next, a description will be given of a liquid drainage operation after the power generation has ended in the fuel cell system according to the first embodiment of the present invention, referring to FIG. 8.

After the power generation has ended, the valve 3 is closed, and the fuel supply pump 4 is stopped. The controller 100 controls the circulation pump 6 to rotate reversely, whereby the check valve 7 is closed. Accordingly, the pressure in the fuel flow channel 21 in the cell 1 is reduced, and atmospheric air is taken in through the gas outlet 19. The fuel in the cell 1 is extruded by the force of the intake air, and is collected into the buffer tank 5 through the fuel inlet 17. The cell 1 has a plurality of branch flow channels therein. Accordingly, it is possible that, in a part of the cell 1, the fuel may remain without being drained. However, even if the fuel remains in a part of the cell 1, the remaining fuel does not deteriorate performance. After the fuel is drained from the inside of the cell 1, the circulation pump 6 is stopped, the liquid drainage operation is completed, and the cell 1 is inoperative.

In accordance with the first embodiment of the present invention, the check valve 7 is disposed on the route between the buffer tank 5 and the fuel outlet 18, and the circulation pump 6 is rotated reversely at the time of the liquid drainage operation, whereby the reverse flow is created. In such a way, the liquid drainage operation can be performed by a simple mechanism without adding an active valve and pump. As a result, it is possible to prevent performance deterioration of the cell 1.

Note that the check valve 7 used in the first embodiment of the present invention does not require electric power for the operation thereof, and an open/close state of the valve is determined only by a pressure difference between a front and rear of the valve. The check valve 7 is compact and has a simple structure, and does not require an electrical controller. Accordingly, the check valve 7 is simple and quickly responsive.

An electromagnetic valve has an advantage in being capable of performing an open/close operation positively at an arbitrary point of time; however, it is disadvantageous in terms of downsizing the power supply since electric power is required for the open/close operation. Specifically, a general electromagnetic valve is either in a closed state or an open state, depending on whether it is energized or not, and is required to be continuously energized in order to shift to a contrary state and to maintain the state. It is not desirable that the fuel cell system use devices which require electric power when the fuel cell system is in a stopped state. Accordingly, an electromagnetic valve that requires electric power in order to maintain the open state when the fuel cell system is in an operation state will decrease power generation efficiency.

Moreover, there are other types of electromagnetic valves include a valve in which electric power is required only when the open/close state is changed, and power is not required in order to maintain the open/close state. However, in theory, it is difficult to fabricate a valve of this type which has a small size and a small pressure loss upon opening. Moreover, when an impact is applied to an electromagnetic valve, an open/close state is sometimes changed.

Furthermore, by continuously rotating the circulation pump 6 for a long time at the time of the liquid drainage operation, the air taken in from the atmosphere will enter the circulation pump 6 through the cell 1 after the liquid has been removed from the cell 1. The circulation pump 6 sucks the gas, and thereby the circulation pump 6 goes into an idling state. As a result, the liquid supply capability thereof is decreased to an extreme in the case of supplying the fuel in the forward direction at the next time of generating electric power. As opposed to this, if the pump can maintain a current state where fuel remains slightly in the circulation pump 6 before idling, then it is possible to usually quickly supply the liquid at the next time of generating electric power.

Accordingly, a mode may be adopted, in which a detector such as a liquid detector and a bubble detector is provided in the route, so as to determine whether or not the fuel has been drained from the cell 1 in response to an output value provided by the detector, and to control the operation of the circulation pump 6. When it is determined that the fuel has been drained from the cell 1, the circulation pump 6 is stopped before starting to idle. For example, the liquid amount detector 50 detects a liquid level in the buffer tank 5, and the controller 100 controls the circulation pump 6.

Moreover, another mode may be adopted, in which a time required for the fuel to be drained from the cell 1 is measured in advance, and the circulation pump 6 is controlled by the controller 100 so as to rotate reversely based on the predetermined measured time. In such a way, even a simple control system without a detector can control the circulation pump 6 to stop before idling.

### SECOND EMBODIMENT

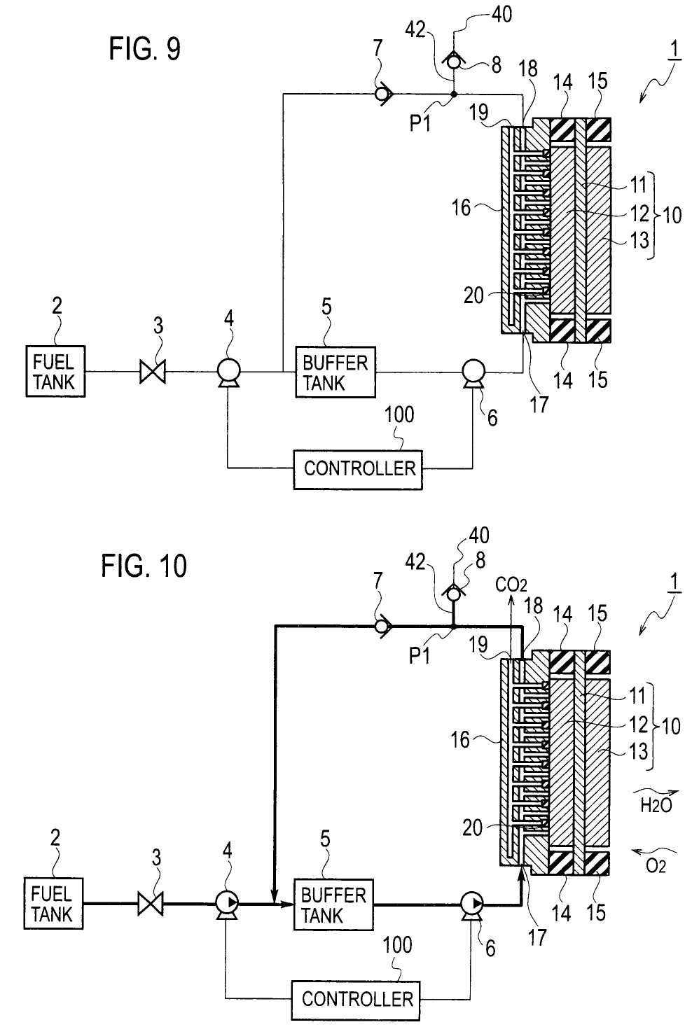

As shown in FIG. 9, in terms of a configuration, a fuel cell system according to a second embodiment of the present invention is different from that of the first embodiment in further including an air intake port 40 provided to a branched pipe 42 of a branching portion P1 between the fuel outlet 18 and the check valve 7; and a check valve 8 that is disposed on the branched pipe 42. The check valve 8 permits a flow of air from the air intake port 40 to the branching portion P1, and shuts off a flow of the unreacted fuel and the like from the branching portion P1 to the air intake port 40. Other configurations of the fuel cell system according to the second embodiment are substantially similar to the configurations of the fuel cell system according to the first embodiment shown in FIG. 1. Accordingly, a duplicate description will be omitted.

At the time of the normal operation, as shown in FIG. 10, the unreacted fuel discharged from the fuel outlet 18 flows through the check valve 7 by pushing and opening the same check valve 7, and returns to the buffer tank 5. Since a pressure of the fuel on the branching portion P1 is higher than the atmospheric pressure, the check valve 8 closes. Accordingly, the flow of the unreacted fuel and the like from the branching portion P1 to the air intake port 40 is shut off.

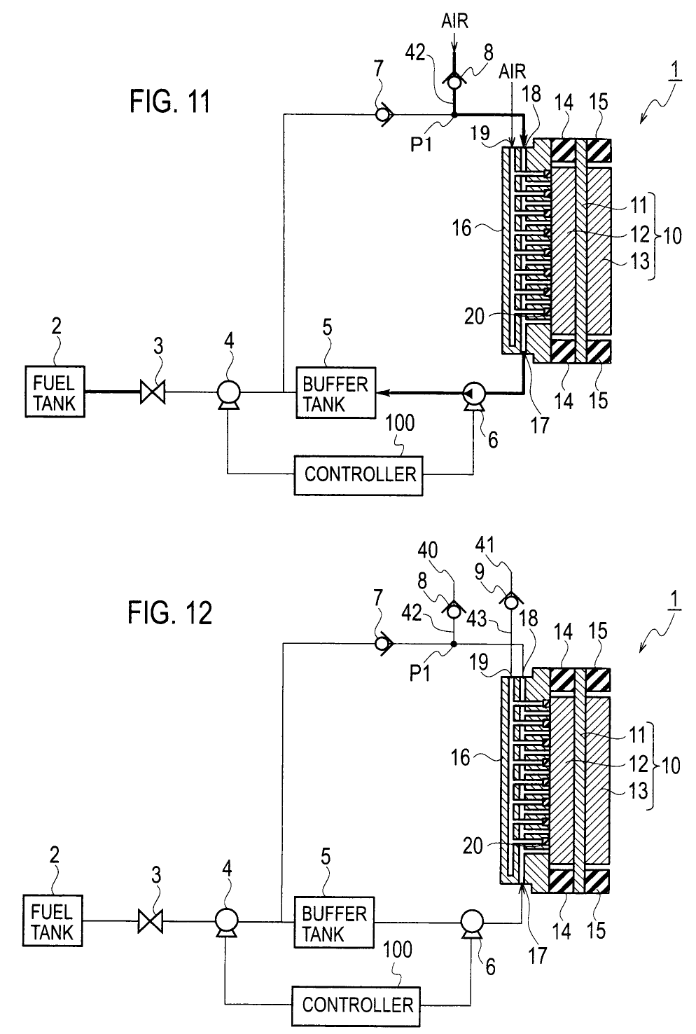

At the time of the liquid drainage operation, as shown in FIG. 11, the circulation pump 6 is controlled by the controller 100 so as to rotate reversely, whereby the check valve 7 closes, and the flow of the fuel from the buffer tank 5 toward the check valve 7 is shut off. Accordingly, the pressure of the fuel at the branching portion P1 drops to atmospheric pressure or lower. Therefore, the check valve 8 opens, and the atmospheric air is taken in from the air intake port 40, and flows into the cell 1 through the fuel outlet 18. Simultaneously, the fuel that has remained in the cell 1 is collected to the buffer tank 5 through the circulation pump 6.

In accordance with the second embodiment of the present invention, the fuel cell system includes: the air intake port 40; and the check valve 8, thus making it possible to drain the liquid by taking in atmospheric air from the air intake port 40.

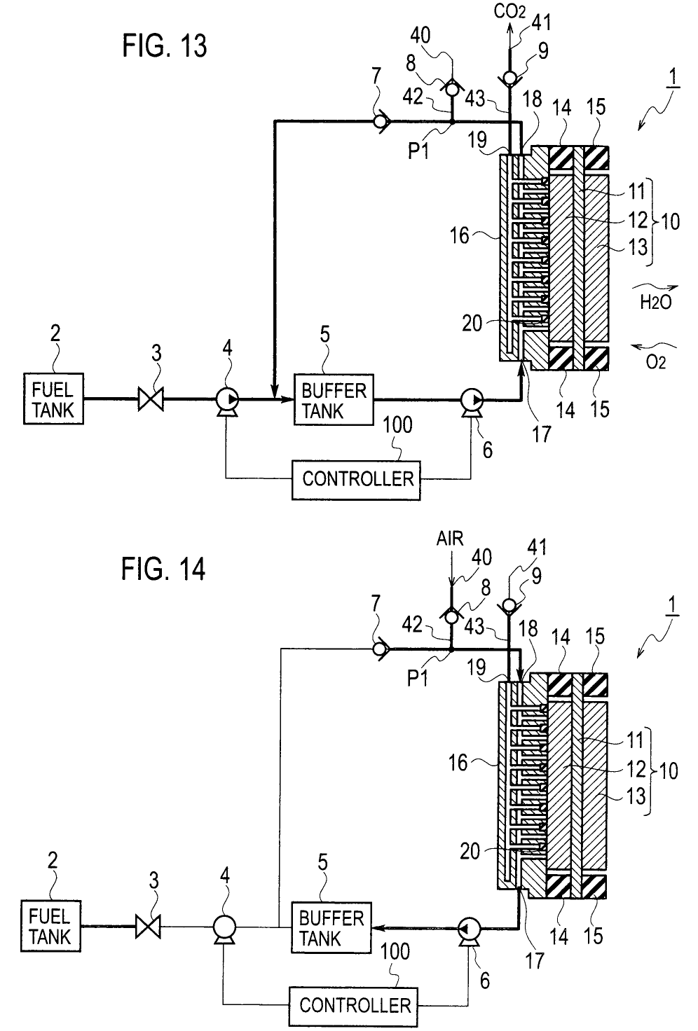

Moreover, as shown in FIG. 12, a configuration may be adopted, in which a discharge port 41 is provided for the gas outlet 19, and a check valve 9 that permits a gas flow from the gas outlet 19 to the discharge port 41 and shuts off a gas flow from the discharge port 41 to the gas outlet 19 is provided on a route 43 between the gas outlet 19 and the discharge port 41. As shown in FIG. 13, at the time of the normal operation, the check valve 9 opens, and CO₂ discharged from the gas outlet 19 is discharged to the atmosphere through the discharge port 41. At the time of the liquid drainage operation, as shown in FIG. 14, the check valve 9 closes, and the gas flow from the discharge port 41 to the gas outlet 19 is shut off.

In the liquid drainage operation, there is a possibility that a part of the fuel in the fuel flow channel 21 may not be drained, only the air taken in from the gas outlet 19 may return to the circulation pump 6, and the liquid drainage may not be performed sufficiently. However, the gas outlet 19 is closed by using the check valve 9, thus making it possible to drain the liquid more surely. It has been experimentally confirmed that, when the gas outlet 19 is actually closed, an amount of the collected fuel is increased as compared with the case where the gas outlet 19 is not closed.

### THIRD EMBODIMENT

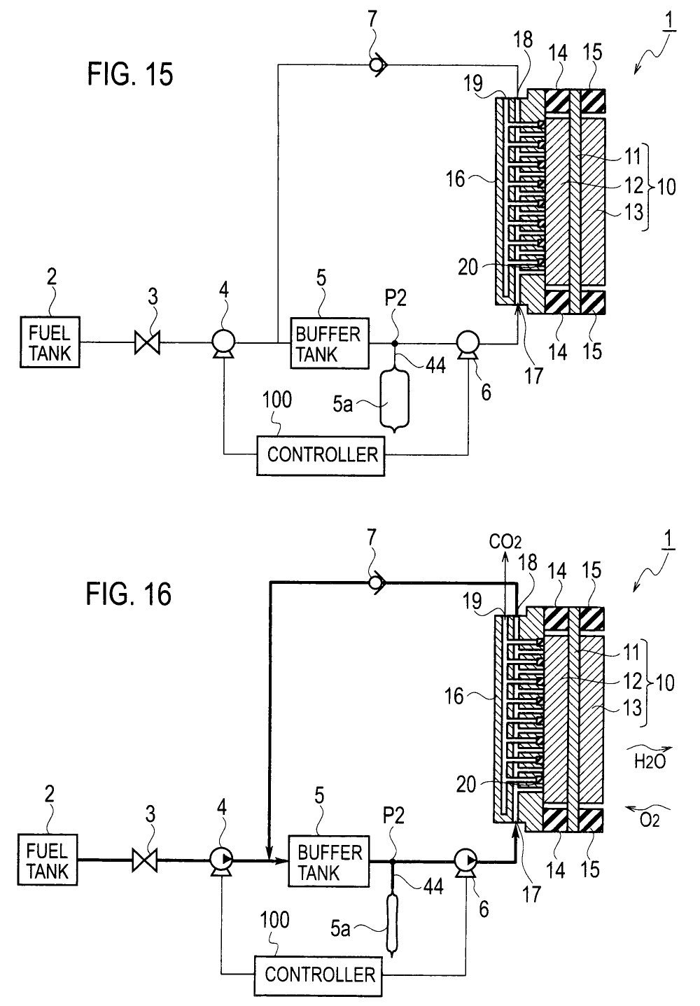

As shown in FIG. 15, a fuel cell system according to a third embodiment of the present invention is different from that of the first embodiment in further including a sub tank 5a provided to a branched pipe 44 of a branching portion P2 between the buffer tank 5 and the circulation pump 6. As the sub tank 5a, a flexible container, such as a plastic bag, is usable. Other configurations of the fuel cell system according to the third embodiment are substantially similar to the configurations of the fuel cell system according to the first embodiment shown in FIG. 1. Accordingly, a duplicate description will be omitted.

At the time of the normal operation, as shown in FIG. 16, as the circulation pump 6 supplies the fuel in the forward direction, the pressure on the inlet side of the circulation pump 6 decreases. At the time of the usual operation, the branching portion P2 is sucked by the circulation pump 6, and accordingly, the fuel in the sub tank 5a is sucked out.

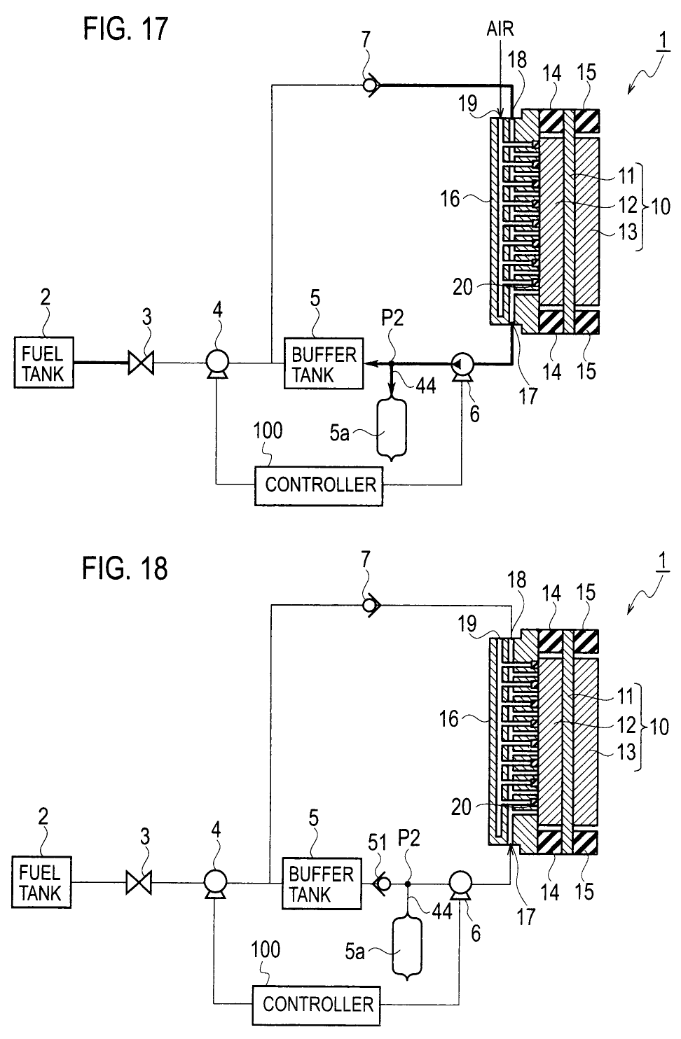

At the time of the liquid drainage operation, as shown in FIG. 17, the circulation pump 6 is controlled so as to rotate reversely, the atmospheric air is taken into the cell 1 through the gas outlet 19. Accordingly, the fuel is discharged from the inside of the cell 1 through the fuel inlet 17, and is collected in the buffer tank 5 and the sub tank 5a. The internal pressure of the buffer tanks changes due to the resilience of a flexible container in response to the capacity thereof; however, if the sub tank 5a having a smaller resilience than the buffer tank 5 is used, then it is easy to collect the fuel to the sub tank 5a.

At the time when the fuel cell system is restarted, first, the fuel in the sub tank 5a is sucked out, and thereafter, the fuel in the buffer tank 5 starts to be circulated. The fuel circulates while pushing out the air in the cell 1 and the air is discharged by the gas-liquid separation layer 20 from the gas outlet 19 to the atmosphere, and the fuel starts to circulate.

A liquid amount detector (not shown) is provided in the buffer tank 5, and accordingly, it is desirable that the capacity of the buffer tank 5 be compact enough to allow the liquid amount detector to detect a liquid level with sufficient accuracy. However, if the capacity of the buffer tank 5 is small, then a space into which the fuel is to be collected from the cell 1 is small. In accordance with the third embodiment of the present invention, the sub tank 5a is provided, whereby the fuel collected from the cell 1 can be sufficiently retained.

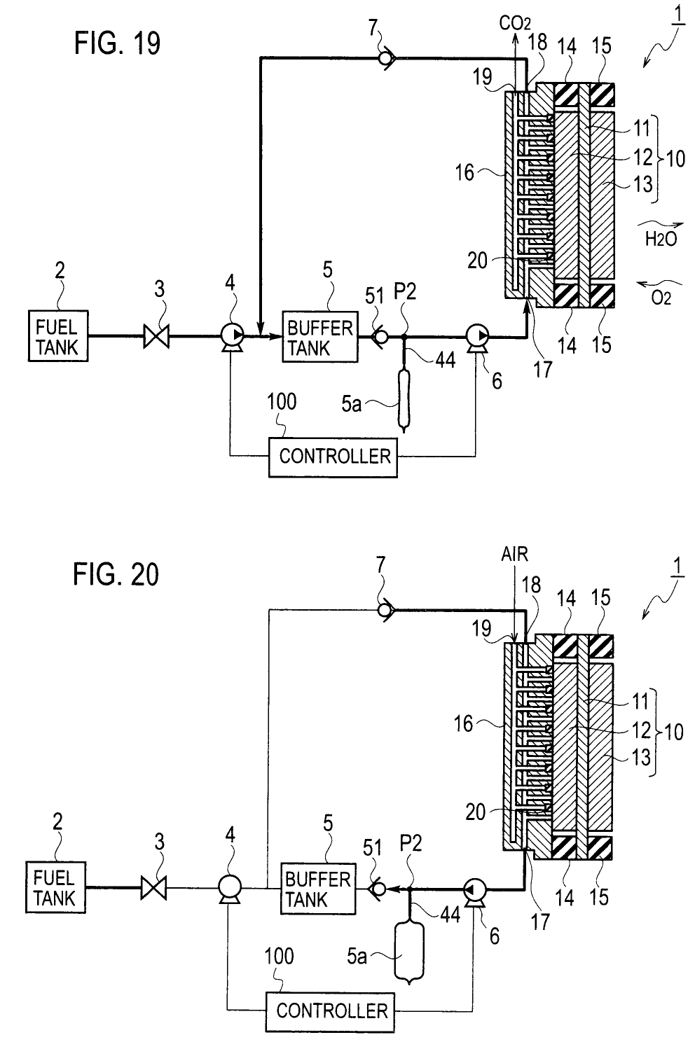

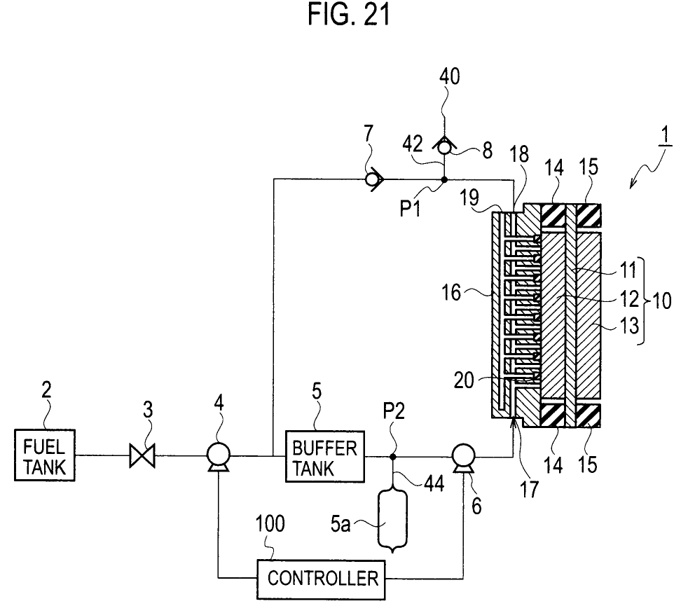

Moreover, as shown in FIG. 18, a check valve 51 that permits a fuel flow from the buffer tank 5 to the branching portion P2 and shuts off a fuel flow from the branching portion P2 to the buffer tank 5 may be provided on the route between the buffer tank 5 and the branching portion P2. As shown in FIG. 19, at the time of the normal operation, the check valve 51 causes a pressure loss, and the branching portion P2 connected to the sub tank 5a is set at a negative pressure. Accordingly, the fuel in the sub tank 5a is sucked out. As shown in FIG. 20, when the circulation pump 6 is controlled so as to rotate reversely, the check valve 51 closes. Accordingly, the fuel discharged from the cell 1 through the fuel inlet 17 is collected to the sub tank 5a without returning to the buffer tank 5. As described above, the sub tank 5a can be made to function more efficiently.

Furthermore, in place of the check valve 51, a diaphragm may be provided between the branching portion P2 and the buffer tank 5. In this case, at the time of the usual operation, the sub tank 5a maintains a collapsed state. At the time of the liquid drainage operation, the fuel discharged from the cell 1 through the fuel inlet 17 is more likely to flow into the sub tank 5a than into the buffer tank 5 because of a pressure loss caused by the diaphragm. Accordingly, the sub tank 5a can be made to function more efficiently.

### OTHER EMBODIMENTS

Various modifications will become possible for those skilled in the art after receiving the teachings of the present disclosure without departing from the scope thereof.

For example, as shown in FIG. 21, the sub tank 5a described in the third embodiment may be added to the configuration of the fuel cell system according to the second embodiment. Moreover, elements for stably operating the fuel cell system, for example, such as a temperature detector, a concentration detector and a filter can be assembled to arbitrary positions of the above-described system.

What is claimed is:

1. A fuel cell system comprising:
a fuel tank to store fuel;
a buffer tank to store the fuel supplied from the fuel tank;
a cell comprising: an electrolyte membrane;
an anode electrode and a cathode electrode sandwiching the electrolyte membrane; and
an anode flow channel plate having a fuel inlet to supply the fuel to the anode electrode and a fuel outlet to discharge the fuel,
the cell to generate power by reaction of the fuel supplied to the anode electrode with air supplied to the cathode electrode;
a circulation pump to circulate the fuel in a forward direction from the buffer tank and returning to the buffer tank through the fuel inlet and the fuel outlet, during the generation of the power; and
a first check valve provided in a route between the fuel outlet and the buffer tank, and to allow flowing the fuel in the forward direction, and to shut off flowing the fuel in a reverse direction,
wherein the circulation pump rotate reversely so as to flow the fuel in the reverse direction and to collect the fuel discharged from the cell through the fuel inlet to the buffer tank, after completion of the generation of the power.

2. The system of claim 1, further comprising:
a branching portion provided between the first check valve and the cell;
a air intake port provided to a branched pipe of the branching portion; and
a second check valve provided in the branched pipe, to shut off flow from the branching portion to the air intake port.

3. The system of claim 2, wherein the air intake port takes in air by reverse rotation of the circulation pump.

4. The system of claim 1, wherein the anode flow channel plate further comprises a gas outlet to discharge gas from the anode electrode.

5. The system of claim 4, further comprising:
a discharge port connected to the gas outlet;
a second check valve provided between the gas outlet and the discharge port, and to shut off flow from the discharge port to the gas outlet.

6. The system of claim 4, wherein the gas outlet takes in air by reverse rotation of the circulation pump.

7. The system of claim 1, further comprising:
a liquid amount detector to detect a liquid level in the buffer tank; and
a controller to control the circulation pump based on the detected liquid level.

8. The system of claim 1, further comprising:
a branching portion provided between the buffer tank and the fuel inlet; and
a sub tank connected to a branched pipe of the branching portion.

9. The system of claim 8, further comprising:
a second check valve provided between the buffer tank and the branching portion, and to shut off flow from the branching portion to the buffer tank.

10. A method for controlling a fuel cell system comprising:
a fuel tank to store fuel;
a buffer tank to store the fuel supplied from the fuel tank;
a cell comprising: an electrolyte membrane; an anode electrode and a cathode electrode sandwiching the electrolyte membrane; and an anode flow channel plate having a fuel inlet to supply the fuel to the anode electrode and a fuel outlet to discharge the fuel, the cell to generate power by reaction of the fuel supplied to the anode electrode with air supplied to the cathode electrode;
a circulation pump to circulate the fuel in a direction starting from the buffer tank and returning to the buffer tank through the fuel inlet and the fuel outlet, defined as a forward direction; and
a check valve provided in a route between the fuel outlet and the buffer tank, and to allow flowing the fuel in the forward direction, and to shut off flowing the fuel in a reverse direction,
the method comprising:
rotating reversely the circulation pump so as to flow the fuel in the reverse direction and to collect the fuel discharged from the cell through the fuel inlet to the buffer tank, after completion of the generation of the power.
